(19) United States
(12) Patent Application Publication
(10) Pub. No.: US 2025/0313920 A1
(43) Pub. Date: Oct. 9, 2025

(54) EXTRACTION OF RARE EARTH ELEMENTS FROM INDUSTRIAL WASTE AND OTHER MATERIALS

(71) Applicant: Spearstone Solutions, LLC, Birmingham, AL (US)

(72) Inventors: Nicole Stone, Marietta, GA (US); Edmond Watters, Birmingham, AL (US); Christopher Cagle, Temple, GA (US)

(73) Assignee: Spearstone Solutions, LLC, Birmingham, AL (US)

(21) Appl. No.: 19/097,669

(22) Filed: Apr. 1, 2025

Related U.S. Application Data
(60) Provisional application No. 63/574,000, filed on Apr. 3, 2024.

(51) Int. Cl. C22B 59/00; B09B 3/70; C22B 1/24; C22B 7/00

(52) U.S. Cl. CPC C22B 59/00; B09B 3/70; C22B 1/24; C22B 7/006

(57) ABSTRACT

The present disclosure provides a method for extracting rare earth elements from industrial waste and other materials. The method includes pre-treating a starting material including but not limited to materials containing coal, coal ash, and mined aggregates, combining the pre-treated starting material with a first aqueous solution comprising one or more ionic salts in a first stage reactor to form a first slurry containing double-salt crystals, separating the first slurry in a first stage separator to obtain a double salt solution and separated impurities, combining the double salt solution with a second aqueous solution in a second stage reactor to form a second slurry, and separating the second slurry in a second stage separator to obtain a purified product and a remaining aqueous solution. The method enables efficient extraction of rare earth elements from industrial waste materials while producing a purified product.

### COPYRIGHT AND TRADEMARK STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the disclosure of the invention, and the applicants, make no claim to any trademarks referenced.

### CROSS REFERENCE TO RELATED APPLICATIONS

“This application claims the benefit of U.S. Provisional Patent Application No. 63/574,000, filed on Apr. 3, 2024, which is incorporated by reference herein in its entirety.

### BACKGROUND OF THE INVENTION

### 1) Field of the Invention

The present disclosure relates to methods for processing industrial waste materials, and more particularly to a method for extracting rare earth elements and rare metals from coal, coal ash, and mined aggregates.

### 2) Description of Related Art

Rare earth elements are fundamental to emerging green energy technologies in the United States (e.g., permanent magnet motors for wind turbines and disk drives, hybrid car batteries, compact fluorescent lighting, and/or displays in all types of consumer/defense electronics), as well as other usages such as industrial catalysts for refining heavier crude oil, automobile catalytic converters, and/or as alloying elements. Presently, rare earth elements are primarily obtained through mining.

Coal-fired power plants generate substantial amounts of industrial waste, including coal ash and flue gas desulfurization (FGD) gypsum. These byproducts often contain heavy metals and other contaminants that can pose environmental and health risks if not properly managed. Coal ash, comprising fly ash and bottom ash, is one of the largest sources of industrial waste in many countries. Similarly, FGD gypsum is produced in large quantities as a result of emissions control processes.

Coal ash and other industrial waste materials have long been recognized as potential sources of valuable elements, including rare earth elements (REEs). These elements play crucial roles in various industries, from electronics to renewable energy technologies. However, extracting REEs from industrial waste has presented challenges due to their low concentrations and complex chemical compositions.

It is also known that coal from certain regions of the world can be particularly rich in rare earth elements, approaching a total concentration of about 1000 parts-per-million (“ppm”). The combustion of coal in power plants for energy generation concentrates non-volatile minerals in the ash by about ten times, to about 10,000 ppm, or on the order of approximately 1%. Coal ash is the product of burning coal. Coal ash can be comprised of fly ash and bottom ash. Fly ash can be ash that rises with flue gases. Bottom ash can be ash that is found at the bottom of a furnace. Fly ash can be collected before the flue gases reaches the chimney of power plants.

Traditional methods for extracting REEs from industrial waste often involve harsh chemical processes that can be environmentally damaging and economically inefficient. These methods frequently require large amounts of energy and generate additional waste streams, limiting their widespread adoption.

The increasing demand for REEs, coupled with concerns about supply chain security, has driven interest in developing more efficient and environmentally friendly extraction techniques. Researchers have explored various approaches, including physical separation, chemical leaching, and biological processes, to improve REE recovery from industrial waste materials.

As noted, coal ash, in particular, has garnered attention as a potential domestic source of REEs. The high volumes of coal ash produced by power plants and stored in ash ponds represent a substantial untapped resource. However, the heterogeneous nature of coal ash and the low concentrations of REEs present technical challenges for extraction.

Currently, the global supply of REEs is dominated by a small number of producers, leading to concerns about supply chain resilience and geopolitical dependencies. As a result, there is growing interest in developing alternative sources of REEs, including from industrial waste streams.

Extracting REEs and other valuable materials from coal ash and similar waste products could potentially serve multiple purposes: reducing the volume of waste requiring storage, mitigating environmental risks, and providing a domestic source of critical materials. However, as noted there are problems with the existing extraction methods that often involve complex processes, harsh chemicals, or high energy inputs. These issues limits their economic and environmental viability.

Therefore, there is a need for improved methods to process coal ash, FGD gypsum, and similar industrial waste materials. Ideally, such methods would efficiently separate contaminants, extract valuable elements, and produce cleaner byproducts suitable for beneficial use. Developing more effective and environmentally friendly approaches to managing these materials could have significant implications for waste reduction, resource recovery, and environmental protection in the energy sector and beyond.

Furthermore, there is an ongoing need for improved methods to extract REEs and other valuable materials from industrial waste streams. Advancements in this field could potentially address environmental concerns associated with waste storage while providing a new source of critical elements for various industries.

These and other objects, features, and advantages of the present invention will become more readily apparent from the attached drawings and the detailed description of the preferred embodiments, which follow.

### SUMMARY OF THE INVENTION

Bearing in mind the problems and deficiencies of the prior art, it is therefore an object of the present invention to provide a method for cleaning and extracting impurities from coal, coal ash, and mined aggregates.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

The instant invention can be used to extract valuable rare earth elements (REEs) from synthetic gypsums and coal ash, providing a domestic and environmentally friendly source of REE production.

According to an aspect of the present disclosure, a method for cleaning and extracting impurities from coal, coal ash, and mined aggregates is provided. The method includes pre-treating starting materials comprising coal, coal ash, and mined aggregates, reacting the pre-treated starting materials in an aqueous solution, forming a slurry containing double-salt crystals, hydrolyzing impurities to break down chemical bonds, excluding impurities from the formed slurry, removing impurities from the formed slurry, and separating the starting materials from the remaining slurry.

According to other aspects of the present disclosure, the method may include one or more of the following features. The pre-treating by supplementing the starting materials with a calcium product to improve calcium content. The pre-treating may also comprise grinding or crushing the starting materials to obtain a preferred particle size. The aqueous solution may comprise one or more ionic salts, with at least one containing ammonium and sulfate. The reacting step may be performed at a temperature of at least 35° C. but no greater than 100° C. The reaction may be conducted for at least 5 minutes at a pressure of at least 1 atm, however longer times are acceptable. The time period for this reaction can be from 5 to 65 minutes and depends on the composition of the starting material. The method may further comprise cooling the slurry and adding a seed solution to promote precipitation or crystallization. The method may also include maintaining the temperature of the double-salt crystals to prevent decomposition and reformation with impurities.

According to another aspect of the present disclosure, a method for extracting rare earth elements and rare metals from industrial waste and other materials is provided. The method includes pre-treating starting materials comprising coal, coal ash, and mined aggregates, combining the pre-treated starting materials with an aqueous solution, mixing and heating to create a slurry containing double-salt crystals, breaking the crystal lattice of the starting materials to release impurities, rare metals, radioactive elements, and rare earth elements, and separating the released elements from the slurry.

According to other aspects of the present disclosure, the method may include one or more of the following features. The pre-treating may comprise increasing calcium content of the starting materials. The pre-treating may comprise grinding or crushing the starting materials to obtain a particle size between 20-120 μm. The method may further comprise performing magnetic separation on the starting materials. The aqueous solution may comprise one or more ionic salts at a concentration of 25% or higher by mass. The mixing and heating step may be performed at a temperature of at least 60° C. and preferably 80° C. however the range may include temperatures from 35° C. to 100° C. The mixing and heating step may be carried out for between 5 and 120 minutes at a pressure between 1 to 4 atm. The method may achieve extraction of greater than 85% of rare earth elements, rare metals, and impurities from the starting materials.

The foregoing general description of the illustrative embodiments and the following detailed description thereof are merely exemplary aspects of the teachings of this disclosure and are not restrictive.

Still other objects and advantages of the invention will in part be obvious and will in part be apparent from the specification.

The above and other objects, which will be apparent to those skilled in the art, are achieved in the present invention which is directed to a method for extracting rare earth elements from industrial waste and other materials, comprising:
a. pre-treating a starting material selected from materials including but not limited to materials containing coal, coal ash, and mined aggregates;
b. combining the pre-treated starting material with a first aqueous solution comprising one or more ionic salts in a first stage reactor to form a first slurry containing double-salt crystals;
c. separating the first slurry in a first stage separator to obtain a double salt solution and separated impurities;
d. combining the double salt solution with a second aqueous solution in a second stage reactor to form a second slurry; and
e. separating the second slurry in a second stage separator to obtain a purified product and a remaining aqueous solution.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 illustrates a process flow diagram for cleaning and extracting materials from coal, coal ash, and mined aggregates, according to aspects of the present disclosure.

FIG. 2 depicts a flowchart of a method for extracting rare earth elements from coal, coal ash, and mined aggregates, in accordance with example embodiments.

FIG. 3 shows a flowchart of a method for cleaning coal, coal ash, and mined aggregates while extracting rare earth elements and rare metals, according to an embodiment.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure be considered as an example of the principles of the invention and not intended to limit the invention to the specific embodiments shown and described.

As used in this disclosure the term microns, also known as micrometers, is represented as μm, which is a length of measurement equal to one millionth of a meter.

As used in this disclosure the term “seed solution” or “seed crystal” refers to a small, well-formed crystal of a substance added to a supersaturated solution to initiate and promote the growth of larger, more uniform crystals through a process called crystallization.

As used in this disclosure the term beneficiation refers to the process of treating ore (rock containing valuable minerals) to improve its quality and make it more suitable for subsequent processing.

The following description sets forth exemplary aspects of the present disclosure. It should be recognized, however, that such description is not intended as a limitation on the scope of the present disclosure. Rather, the description also encompasses combinations and modifications to those exemplary aspects described herein.

Prior to a discussion of the preferred embodiment of the invention, it should be understood that while the features and advantages of the invention are illustrated in terms of a methods for processing industrial waste and other materials, and more particularly to a method for extracting rare earth elements and rare metals from coal, coal ash, and mined aggregates. This method provides an efficient and environmentally friendly approach to recovering valuable elements while simultaneously cleaning and purifying the source materials.

The present disclosure relates to a method for extracting rare earth elements and rare metals from industrial waste and other materials such as but not limited to coal, coal ash, and mined aggregates. This method may provide an efficient and environmentally friendly approach to recovering valuable elements while simultaneously cleaning and purifying the source materials.

In some cases, the disclosed method may involve pre-treating the starting materials, reacting them in an aqueous solution, and separating out impurities and valuable elements. The process may break down chemical bonds and exclude contaminants from the treated materials. This approach may allow for the extraction of rare earth elements and rare metals without relying on harsh chemical leaching or extreme processing conditions.

The method described herein may achieve high extraction rates of rare earth elements, rare metals, and other impurities from the starting materials. In some cases, the process may extract over 85% of these valuable components. This high extraction efficiency allows for significant recovery of elements that have increasing importance in various industries and technologies.

By providing a means to extract these elements from industrial waste and other materials, the present invention may offer several potential benefits. The method may reduce reliance on traditional mining operations for rare earth elements and rare metals, which can have significant environmental impacts. Additionally, the process may help address the growing demand for these elements in various applications, including renewable energy technologies, electronics, and advanced materials.

The extraction method described in this disclosure may be applied to a range of industrial waste and other materials, allowing for flexibility in sourcing and processing. This versatility may enable the method to be adapted for use in different regions or with varying waste streams, potentially increasing its utility and impact.

The method described herein may involve pre-treatment of the starting materials, which may include coal, coal ash, and mined aggregates. Pre-treatment processes may be employed to prepare the materials for subsequent extraction steps and to improve overall extraction efficiency.

In some cases, the pre-treatment process may include magnetic separation. This step may be used to remove ferromagnetic materials from the starting materials. Magnetic separation may help reduce impurities and improve the purity of the final product. The ferromagnetic materials can then be processed and sent to recycling.

In one embodiment the pre-treatment process involves calcium enrichment of the starting materials. Calcium-containing compounds such as gypsum or calcium carbonate are added to the coal, coal ash, or mined aggregates to increase their calcium content. This calcium enrichment step enhances the formation of double salt crystals in subsequent processing steps.

Another pre-treatment step that can be employed is particle size reduction. The starting materials may be ground or crushed to obtain a specific particle size range. In some cases, the target particle size after grinding may be between 20 and 120 micrometers (μm) however other sizes are effective depending on the type and composition of the starting materials. This size reduction increases the surface area of the particles, potentially improving the efficiency of subsequent extraction processes.

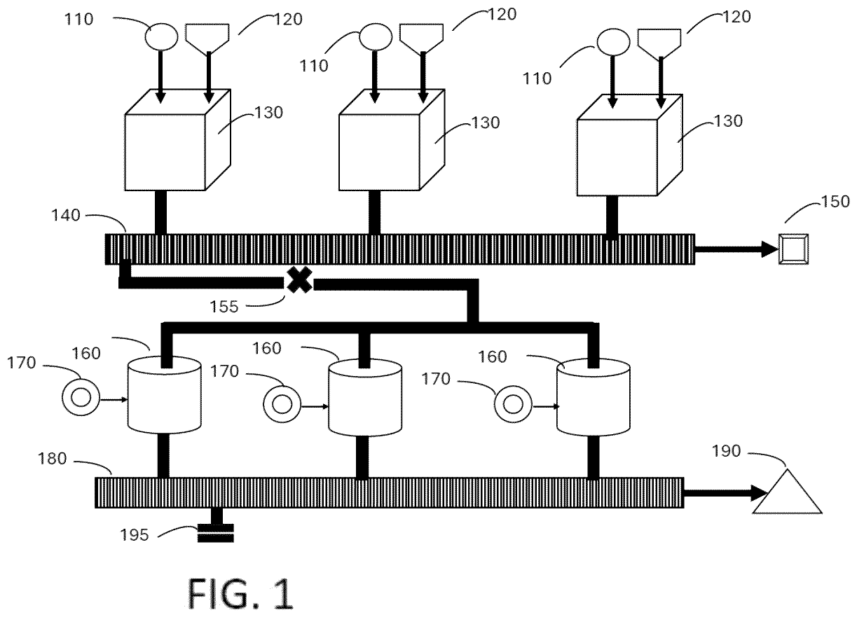

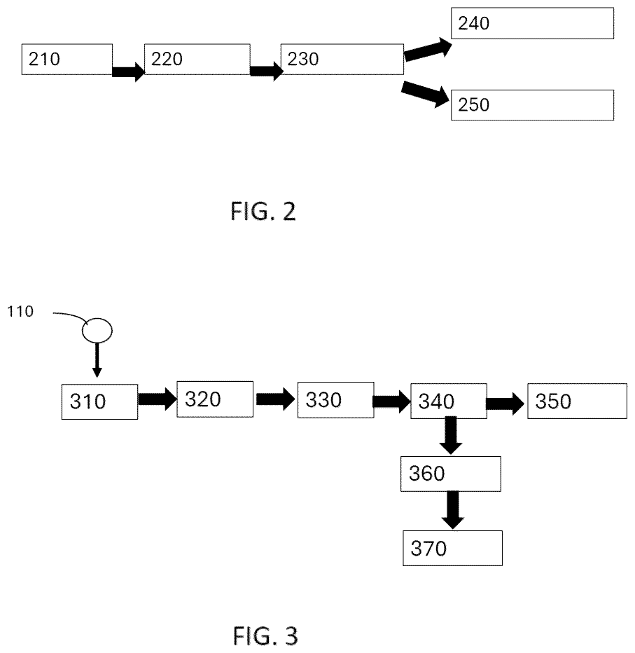

As illustrated in FIG. 1, FIG. 2 and FIG. 3 the pre-treatment stage may occur after the input of coal, coal ash, or other mined aggregates from a pond or landfill. The pre-treatment process may prepare the materials for the subsequent extraction and metal/REE control stages. In some instances, the pretreatment includes a dewatering process to remove water from the starting material. This is primarily used when the starting material is stored in a pond or landfill

The specific pre-treatment methods employed may vary depending on the characteristics of the starting materials and the desired outcomes of the extraction process. For example, coal ash with high iron content may benefit more from magnetic separation, while materials with naturally low calcium content may require more extensive calcium enrichment.

By employing these pre-treatment steps the starting materials are optimized for more efficient extraction of rare earth elements, rare metals, and other valuable components in the subsequent processing stages.

The method may involve a first stage reaction process where the pre-treated starting materials are combined with aqueous ionic salt solutions. As shown in FIG. 1, a first stage reactor 130 may be used to carry out this initial reaction step.

As shown in FIG. 1 the coal, coal ash, or mined aggregate minerals may be added to one or more first stage reactors 1. This arrangement may allow for a partially continuous process. The starting materials 110 may be combined with a first-stage aqueous solution comprising one or more ionic salts. In some embodiments, at least one of the ionic salts can contain ammonium and sulfate. The concentration of the aqueous solution in this embodiment may be 25% or higher by mass.

The mixture in the first stage reactor 130 may be heated to form a slurry. The reaction temperature may be at least 35° C. however higher reaction temperatures are permissible depending on the composition of the starting material 110. The specific optimum temperature and duration of the reaction for heating depends on the particular starting material 110 used.

The residence time of the reaction between the starting materials and the aqueous solution in the first stage reactor 130 may be at least 5 minutes. The reaction may be carried out at a pressure of at least 1 atm. The specific pressure and time used may vary depending on the starting material.

During the reaction in the first stage reactor 130, a slurry containing double salt crystals may form. This process breaks the calcium bonds within the minerals and hydrolyze the impurities previously included in the coal, coal ash, or mined aggregate minerals. The formation of the crystalline compound breaks the crystal lattice of the starting materials, releasing impurities, rare metals, radioactive elements, and rare earth elements.

In some embodiments, once the double salt is created, the solution may be cooled. A seed solution may be added, as necessary, to promote precipitation or crystallization. When allowed to settle, the impurities and rare earth elements precipitate from the slurry into a solid or semi-solid layer. Prior to transferring to another processing step the solid or semi-solid layer may need to be dewatered.

As illustrated in FIG. 2, the extraction process may involve the formation of double salt crystals. This step may be crucial for separating the valuable elements and impurities from the starting materials. The double salt separation process shown in FIG. 2 may correspond to the output from the first stage reactor 130 and subsequent processing steps.

Following the reaction in the first stage reactor 130, the resulting slurry may be discharged and sent to a first stage filter/separator 140, as illustrated in FIG. 1. The first stage filter/separator 140 may allow for the separation of the double salt solution from solid impurities in the slurry.

In some cases, the first stage filter/separator 140 may be a filter or other mechanical separation device. The separation process can involve allowing the slurry to settle, which may cause impurities and rare earth elements to precipitate from the slurry into a solid or semi-solid layer.

During the separation process, it is important to maintain the temperature of the double salt crystals. Maintaining the crystal temperature prevents the double salt from decomposing and reforming with the impurities. By controlling the temperature, the process of separation of impurities in the solution is more effective.

The separation process in the first stage filter/separator 140 may result in separated impurities 150, as shown in FIG. 1. The separated impurities 150 may include rare earth elements, other metals, other valuable elements, and other contaminants. These separated impurities 150 may be collected for further processing or refinement.

As illustrated in FIG. 2, the double salt separation step may involve processing both a double salt layer and a concentrated metals and rare earth elements (REEs) layer. This separation may correspond to the process occurring in the first stage filter/separator 140.

In some implementations, the separated impurities 150 may require additional separation techniques, depending on the specific products of interest or the composition of the starting materials. For example, different methods may be employed to isolate particular rare earth elements or valuable metals from the mixture of separated impurities.

The double salt solution separated in the first stage filter/separator 140 may be further processed in subsequent stages of the extraction method, as shown in FIG. 1. This continued processing may allow for further purification and recovery of valuable materials from the starting materials.

Following the first stage reaction and separation process, the method may involve a second stage reaction. As illustrated in FIG. 1, a second stage reactor 160 may be used to carry out this subsequent reaction step.

In the second stage reactor 160, the double salt solution obtained from the first stage filter/separator 140 may be mixed with a second stage aqueous solution. This mixing process may create a new slurry within the second stage reactor 160.

The reaction conditions in the second stage reactor 160 may be controlled to optimize the extraction process. In some cases, the mixture in the second stage reactor 160 may be heated to a temperature of at least 10° C. The specific temperature used may depend on the characteristics of the materials being processed and the desired outcomes of the extraction. The second stage reactor 160 may be heated to a temperature between 10° C. to 100° C. depending on starting materials 110 composition.

The residence time of the reaction in the second stage reactor 160 may be carefully controlled. In some implementations, the reaction time may be between 5 and 65 minutes. The specific duration may be adjusted based on factors such as the composition of the double salt solution, the concentration of the second stage aqueous solution, and the target extraction efficiency.

As shown in FIG. 2, the process flow can include a step for double salt separation, which corresponds to the operations occurring in the second stage reactor 160 and subsequent processing steps. The formation of a new slurry in the second stage reactor 160 facilitates further separation and extraction of valuable components from the processed materials.

The slurry formed in the second stage reactor 160 may undergo additional processing to separate the purified product from the remaining solution. This separation process may involve techniques similar to those used in the first stage filter/separator 140, adapted for the specific characteristics of the second stage slurry.

Following the reaction in the second stage reactor 160, the resulting slurry may be sent to a second stage separator 180, as illustrated in FIG. 1. The second stage separator 180 may be used to separate a purified product 190 from the remaining aqueous solution.

In some cases, the second stage separator 180 may employ commercially available mechanical separation methods. These methods may include, but are not limited to, filtration, centrifugation, or sedimentation. The specific separation technique used may depend on factors such as the characteristics of the slurry, the desired purity of the final product, and the efficiency of the separation process.

The purified product 190 obtained from the second stage separator 180 may consist of cleaned coal, coal ash, or mined aggregate, depending on the starting material used in the process. As shown in FIG. 2, the purified product may undergo further beneficiation steps to enhance its quality or prepare it for specific applications.

In some implementations, the purified product 190 may require additional separation or processing steps. The need for further separation may depend on the pre-treatment methods employed earlier in the process. For example, if calcium enrichment was used during pre-treatment, additional steps may be necessary to remove excess calcium from the purified product.

The remaining liquid collected after the separation process in the second stage separator 180 may be recycled for use in subsequent extraction cycles. In some cases, this recycled liquid may be used as an aqueous solution in the first stage reactor 130 or the second stage reactor 160, potentially reducing water consumption and improving the overall efficiency of the extraction process.

By employing this multi-stage reaction and separation process, the method may achieve efficient extraction of rare earth elements and rare metals while also producing a purified product from the initial industrial waste and other materials. The ability to recycle process liquids and potentially recover multiple valuable products may contribute to the economic and environmental benefits of this extraction method.

The extraction process described herein may involve multiple interacting stages that work together to efficiently extract rare earth elements and rare metals from industrial waste materials as well as other materials containing rare earth elements and rare metals. As illustrated in FIG. 1, the process may begin with the introduction of pre-treated starting materials 110 into the first stage reactor 130.

In the first stage reactor 130, the starting materials may be combined with an aqueous ionic salt solution. This combination may initiate a reaction that forms a slurry containing double salt crystals. The formation of these crystals can be crucial for breaking down the structure of the starting materials and releasing the valuable elements and impurities.

From the first stage reactor 130, the slurry may flow into the first stage filter/separator 140. In the first stage filter/separator 140, the double salt solution may be separated from solid impurities. This separation process may result in two main outputs: the separated impurities 150 and the double salt solution.

The separated impurities 150 may contain rare earth elements, other metals, and various contaminants. As shown in FIG. 2, these separated impurities may undergo further processing in a concentrated metals and REEs layer. This additional processing may allow for the recovery of specific valuable elements from the impurity mixture.

The double salt solution from the first stage filter/separator 140 may then flow into the second stage reactor 160. In the second stage reactor 160, the double salt solution may be combined with a second aqueous solution. This combination may create a new slurry, potentially facilitating further extraction or purification of the desired elements.

From the second stage reactor 160, the new slurry may be directed to the second stage separator 180. In the second stage separator 180, the purified product 190 may be separated from the remaining aqueous solution. As illustrated in FIG. 3, this purified product 190 may consist of cleaned coal, coal ash, or other mined aggregates, depending on the starting material used.

The interaction between these process stages may allow for a continuous or semi-continuous flow of materials through the extraction system. Each stage may build upon the previous one, progressively separating and concentrating the valuable elements while removing impurities from the starting materials.

In some cases, the process may involve feedback loops or recycling of materials between stages. For example, the aqueous solution separated in the second stage separator 180 may be recycled for use in earlier stages of the process, potentially improving overall efficiency and reducing waste.

The multi-stage nature of this process may allow for flexibility in handling different types of starting materials. As shown in FIG. 3, the process may accommodate inputs from various sources, such as industrial materials including but not limited to coal ash ponds or landfills, and may produce multiple valuable outputs, including refined rare earth elements and cleaned industrial waste products.

The instant innovation can furthermore be described as a method for extracting rare earth elements from industrial waste and other materials, comprising:
a. pre-treating a starting material selected from materials including but not limited to materials containing coal, coal ash, and mined aggregates;
b. combining the pre-treated starting material with a first aqueous solution comprising one or more ionic salts in a first stage reactor to form a first slurry containing double-salt crystals;
c. separating the first slurry in a first stage separator to obtain a double salt solution and separated impurities;
d. combining the double salt solution with a second aqueous solution in a second stage reactor to form a second slurry; and
e. separating the second slurry in a second stage separator to obtain a purified product and a remaining aqueous solution.

The method of the instant innovation, wherein pre-treating the starting material comprises supplementing the starting material with a calcium product to improve calcium content.

The method of the instant innovation, wherein pre-treating the starting material comprises grinding or crushing the starting material to obtain a particle size between 20-120 μm.

The method of the instant innovation, wherein the first aqueous solution comprises one or more ionic salts at a concentration of 25% or higher by mass.

The method of the instant innovation, wherein combining the pre-treated starting material with the first aqueous solution is performed at a temperature of at least 60° C. for between 5 and 120 minutes.

The method of the instant innovation, wherein the temperature is 80° C. and the pressure is between 1 to 4 atm.

The method of the instant innovation, further comprising recycling the remaining aqueous solution obtained from the second stage separator for use as the first or second aqueous solution in subsequent extraction cycles.

A system for extracting rare earth elements from industrial waste and other materials, comprising:
a. a pre-treatment unit configured to process a starting material selected from materials including but not limited to materials containing coal, coal ash, and mined aggregates;
b. a first stage reactor configured to combine the pre-treated starting material with a first aqueous solution comprising one or more ionic salts to form a first slurry containing double-salt crystals;
c. a first stage separator configured to separate the first slurry into a double salt solution and separated impurities;
d. a second stage reactor configured to combine the double salt solution with a second aqueous solution to form a second slurry; and
e. a second stage separator configured to separate the second slurry into a purified product and a remaining aqueous solution.

The system of the instant innovation, wherein the pre-treatment unit is configured to supplement the starting material with a calcium product to improve calcium content.

The system of the instant innovation, wherein the pre-treatment unit is configured to grind or crush the starting material to obtain a particle size between 20-120 μm.

The system of the instant innovation, wherein the first stage reactor is configured to operate at a temperature of at least 60° C. and a pressure between 1 to 4 atm.

The system of the instant innovation, wherein the first stage reactor is configured to operate for a duration between 5 and 120 minutes. The system the instant innovation, further comprising a recycling unit configured to recycle the remaining aqueous solution obtained from the second stage separator for use as the first or second aqueous solution in subsequent extraction cycles.

The system of the instant innovation, wherein the recycling unit is further configured to adjust the concentration of ionic salts in the recycled aqueous solution to maintain a concentration of 25% or higher by mass.

A method for cleaning industrial waste and other materials and extracting rare earth elements, comprising:
a. pre-treating a starting material selected from materials including but not limited to materials containing coal, coal ash, and mined aggregates to obtain a particle size between 20-120 μm;
b. combining the pre-treated starting material with an aqueous solution comprising one or more ionic salts at a concentration of 25% or higher by mass;
c. heating the combination to a temperature of at least 60° C. to form a slurry containing double-salt crystals;
d. breaking a crystal lattice of the starting material to release rare earth elements; and
e. separating the released rare earth elements from the slurry.

The method of the instant innovation, wherein the aqueous solution comprises at least one ionic salt containing ammonium and sulfate.

The method of the instant innovation, wherein heating the combination is performed at a pressure between 1 to 4 atm for a duration between 5 and 120 minutes.

The method of the instant innovation, wherein the temperature is 80° C.

The method of the instant innovation, further comprising performing magnetic separation on the starting material prior to pre-treating.

The method of the instant innovation, further comprising recycling a remaining aqueous solution obtained after separating the released rare earth elements for use in subsequent extraction cycles

Referring now to the drawings FIG. 1-FIG. 3 the process and methods are disclosed, and particularly FIG. 1, there is shown a process flow diagram for cleaning and extracting materials from coal, coal ash, and mined aggregates, according to aspects of the present disclosure. A pre-treated Coal, coal ash, or mined aggregate starting material 110 and a first stage aqueous ionic salt solution 120 is placed in a first stage reactor 130. The process can use multiple first-stage reactor 130. FIG. 1 can further be described as a step-by-step illustration of the method of cleaning coal, coal ash, and mined aggregates. In the method, the starting materials, coal, coal ash, and mined aggregates, are pre-treated, meaning supplemented with a calcium product, such as gypsum or calcium carbonate, as necessary to improve their calcium content. The starting material is then crushed or ground to a smaller size via a crusher, grinder, or other mechanical means, if necessary.

The starting material 110 is pre-treated to improve its characteristics to ensure high and consistent extraction efficiency. The term pre-treated means to supplemented with a calcium product, such as gypsum or calcium carbonate, as necessary to improve their calcium content and/or meaning utilizing magnetic separation to remove iron. The starting material can then be crushed or ground to a smaller size via a crusher, grinder, or other mechanical means, if necessary. The pre-treatment step is optional, depending on the starting material. It can also be used as a final step in the process. This involves, if necessary, pre-treating a calcium product to increase/improve calcium content and/or grinding or crushing the material to obtain a preferred particle size. The pre-treated material is then combined with an aqueous solution where it is mixed and heated, creating a slurry containing double salt crystals. During the formation of the crystalline compound, the crystal lattice of the coal, coal ash, and mined aggregates is broken, releasing the impurities, rare metals, radioactive elements, and rare earth elements. Pre-treatment is done to obtain a particle size after grinding between 20-120 μm, however other sizes may be used depending on the composition of starting material 110. The pre-treatment can also incorporate magnetic separation and calcium enrichment.

The starting materials 110 can be combined with one or more first stage aqueous ionic salt solution 120 (25% or higher by mass) comprising one or more ionic salts (at least one containing ammonium and sulfate). The mixture is placed in first stage reactor 130 heated to a temperature of at least 35° C. to 100° C. and the preferred temperature is 80° C. to form a slurry, the optimum temperature for heating depends on the starting material used. The residence time of the reaction between starting materials 110 and first stage aqueous ionic salt solution 120 is at least 5 and 120 minutes and carried out at a pressure between 1 to 4 atm, depending on the starting material 110 used. The reaction forms a slurry, containing double salt crystals, breaking the calcium bonds within the minerals and hydrolyzing the impurities previously included in the coal, coal ash, or mined aggregate minerals starting materials 110. Once the double salt is created, the solution can be cooled and a seed solution can be added, as necessary, to promote precipitation or crystallization. When allowed to settle, the impurities and rare earth elements precipitate from the slurry into a solid or semi-solid layer. The slurry is discharged in series from the first stage reactor 130 and sent to the first stage filter/separator 140.

The first stage filter/separator 140 allows for the separation of the double salt from the solid impurities in solution. Most of the impurities released are in solid phase, but some may be dissolved in solution. The double salt crystal temperature is maintained to prevent it from decomposing and allowing the crystal to reform with the impurities. Separation of the impurities in the solution can occur if the temperature is not maintained.

In the separation process, the slurry from the first stage filter/separator 140, containing separated impurities, REEs, other metals, other valuable elements, and other contaminants 150 is sent to further separation (not shown). Depending on the products of interest, the separated impurities, REEs, other metals, other valuable elements, and other contaminants 150 may require further separation techniques.

The output 155 of the first stage filter/separator 140 and the double salt and second stage aqueous solution 170 are mixed in the reactor 160 and heated to a temperature of at least 10° C. for between 5 and 65 minutes. The double salt solution and second stage aqueous solution 170 form a slurry which is sent to a second stage filter/separator 180 where the purified coal, coal ash, or mined aggregate 190 product is separated from the aqueous solution via commercially available mechanical separation methods. The remaining liquid collected after the process is complete can be recycled as an aqueous solution 195. Product 190 may require further separation depending on the pre-treatment methods employed for supplementation.

FIG. 2 depicts a flowchart of a method for extracting rare earth elements from coal, coal ash, and mined aggregates, in accordance with example embodiments. The starting materials 110 are the product inputs 210 which are processed using the extraction process 220. The materials are then processed in a reactor 130 using a double salt separation process 230 and the resulting outputs are input product beneficiation 240 and REE and other element refinement 250.

FIG. 3 shows a flowchart of a method for cleaning coal, coal ash, and mined aggregates while extracting rare earth elements and rare metals, according to an embodiment. The starting materials 110 enters the process at step 310 and the starting materials 110 is pre-treated in step 320 and then treated using the extraction process 330 forming the extraction and concentration of metals and REEs step 340, The concentration of metals and REEs are sent to step 350 which is the REE refiner and the clean coal, coal ash, or other mined aggregates step 360 and these are sent to step 370 future beneficiation.

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments; it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

We claim:

1. A method for extracting rare earth elements from industrial waste, comprising:
pre-treating a starting material selected from coal, coal ash, and mined aggregates;
combining the pre-treated starting material with a first aqueous solution comprising one or more ionic salts in a first stage reactor to form a first slurry containing double-salt crystals;
separating the first slurry in a first stage separator to obtain a double salt solution and separated impurities;
combining the double salt solution with a second aqueous solution in a second stage reactor to form a second slurry; and
separating the second slurry in a second stage separator to obtain a purified product and a remaining aqueous solution.

2. The method of claim 1, wherein pre-treating the starting material comprises supplementing the starting material with a calcium product to improve calcium content.

3. The method of claim 1, wherein pre-treating the starting material comprises grinding or crushing the starting material to obtain a particle size between 20-120 μm.

4. The method of claim 1, wherein the first aqueous solution comprises one or more ionic salts at a concentration of 25% or higher by mass.

5. The method of claim 1, wherein combining the pre-treated starting material with the first aqueous solution is performed at a temperature of at least 60° C. for between 5 and 120 minutes.

6. The method of claim 5, wherein the temperature is 80° C. and the pressure is between 1 to 4 atm.

7. The method of claim 1, further comprising recycling the remaining aqueous solution obtained from the second stage separator for use as the first or second aqueous solution in subsequent extraction cycles.

8. A system for extracting rare earth elements from industrial waste, comprising:
a pre-treatment unit configured to process a starting material selected from coal, coal ash, and mined aggregates;
a first stage reactor configured to combine the pre-treated starting material with a first aqueous solution comprising one or more ionic salts to form a first slurry containing double-salt crystals;
a first stage separator configured to separate the first slurry into a double salt solution and separated impurities;
a second stage reactor configured to combine the double salt solution with a second aqueous solution to form a second slurry; and
a second stage separator configured to separate the second slurry into a purified product and a remaining aqueous solution.

9. The system of claim 8, wherein the pre-treatment unit is configured to supplement the starting material with a calcium product to improve calcium content.

10. The system of claim 8, wherein the pre-treatment unit is configured to grind or crush the starting material to obtain a particle size between 20-120 μm.

11. The system of claim 8, wherein the first stage reactor is configured to operate at a temperature of at least 60° C. and a pressure between 1 to 4 atm.

12. The system of claim 11, wherein the first stage reactor is configured to operate for a duration between 5 and 120 minutes.

13. The system of claim 8, further comprising a recycling unit configured to recycle the remaining aqueous solution obtained from the second stage separator for use as the first or second aqueous solution in subsequent extraction cycles.

14. The system of claim 13, wherein the recycling unit is further configured to adjust the concentration of ionic salts in the recycled aqueous solution to maintain a concentration of 25% or higher by mass.

15. A method for cleaning industrial waste and extracting rare earth elements, comprising:
pre-treating a starting material selected from coal, coal ash, and mined aggregates to obtain a particle size between 20-120 μm;
combining the pre-treated starting material with an aqueous solution comprising one or more ionic salts at a concentration of 25% or higher by mass;
heating the combination to a temperature of at least 60° C. to form a slurry containing double-salt crystals;
breaking a crystal lattice of the starting material to release rare earth elements; and
separating the released rare earth elements from the slurry.

16. The method of claim 15, wherein the aqueous solution comprises at least one ionic salt containing ammonium and sulfate.

17. The method of claim 15, wherein heating the combination is performed at a pressure between 1 to 4 atm for a duration between 5 and 120 minutes.

18. The method of claim 17, wherein the temperature is 80° C.

19. The method of claim 15, further comprising performing magnetic separation on the starting material prior to pre-treating.

20. The method of claim 19, further comprising recycling a remaining aqueous solution obtained after separating the released rare earth elements for use in subsequent extraction cycles.
